(19) United States
(12) Patent Application Publication
(10) Pub. No.: US 2009/0287576 A1
(43) Pub. Date: Nov. 19, 2009

(54) COMMODITY SALES DATA PROCESSING SYSTEM, COMMODITY SALES DATA PROCESSING APPARATUS, AND DISPLAY METHOD FOR TRANSACTION INFORMATION

(75) Inventor: Hiromasa Suzuki, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/465,732

(22) Filed: May 14, 2009

(30) Foreign Application Priority Data
May 15, 2008 (JP) 2008-128286

(51) Int. Cl. G06Q 30/00

(52) U.S. Cl. 705/16

(57) ABSTRACT

A POS apparatus includes a code scanner and a radio communication unit. A store clerk inputs a commodity code from the code scanner. The POS apparatus generates transaction information based on the input commodity code. The radio communication unit transmits and outputs the transaction information. A customer carries a cellular phone. The cellular phone includes a terminal display unit and a radio communication unit. When the radio communication unit receives the transaction information, the terminal display unit displays the received transaction information.

### CROSS REFERENCE TO RELATED APPLICATION

This application is based upon and claims the benefit of priority from Japanese Patent Application No. 2008-128286, filed on May 15, 2008, the entire contents of which are incorporated herein by reference.

### TECHNICAL FIELD

The present invention relates to a commodity sales data processing apparatus that is installed by a store such as a supermarket to perform commodity sales management, a commodity sales data processing system including the commodity sales data processing apparatus and a customer-carried terminal such as a cellular phone, and a display method for transaction information in the system.

### BACKGROUND

Conventionally, a store such as a supermarket installs a POS apparatus (a commodity sales data processing apparatus). The POS apparatus includes a code scanner and a display for customer. The display for customer faces a customer in transaction. An operator inputs a commodity code to the POS apparatus using the code scanner. The POS apparatus displays transaction information on the display for customer every time a commodity code is input. The customer checks, looking at the transaction information, commodities that the customer purchases. The customer checks, looking at the transaction information, whether a store clerk (a checker) makes a mistake in commodity code scanning work.

Some customer does not want others to know commodities that the customer purchases. Such a customer hates the display for customer to display transaction information. Concerning this point, JP-A-H8-22575 discloses that a display for customer includes a blind to prevent transaction information from being shown to customers other than a customer in checkout transaction.

However, the customers may leave a line for checkout when the customers finish checkout transaction. The customers may lean forward to the display for customer while standing in the line for checkout transaction. In these cases, even if the display for customer includes the blind, the customers can see transaction information displayed by the display for customer.

### SUMMARY

It is an object of the present invention to show transaction information only to a customer in checkout transaction.

According to an aspect of the present invention, there is provided a commodity sales data processing system including: a commodity sales data processing apparatus including a commodity-code input unit for inputting a commodity code, a first communication unit that executes near distance radio communication, and a first information processing unit that executes transmission output processing for causing the first communication unit to transmit and output transaction information based on the commodity code input from the commodity-code input unit; and a customer-carried terminal including a terminal display unit that displays information, a second communication unit that executes the near distance radio communication, and a second information processing unit that executes information processing for executing display processing for causing the terminal display unit to display transaction information received by the second communication unit.

According to another aspect of the present invention, there is provided a commodity sales data processing apparatus including: a commodity-code input unit for inputting a commodity code; a first communication unit that executes near distance radio communication; and a first information processing unit that executes transmission output processing for causing the first communication unit to transmit and output transaction information based on the commodity code input from the commodity-code input unit.

According to still another aspect of the present invention, there is provided a display method for transaction information including: by a commodity sales data processing apparatus, which includes a commodity-code input unit for inputting a commodity code and a first communication unit that executes near distance radio communication, transmitting and outputting transaction information based on the commodity code input from the commodity-code input unit; and by a customer-carried terminal, which includes a terminal display unit that displays information and a second communication unit that executes the near distance radio communication, receiving the transaction information and displaying the transaction information on the terminal display unit.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram of an overview of a commodity sales data processing system and a wide area network including the commodity sales data processing system;

FIG. 2 is an external perspective view of a POS apparatus viewed from a store clerk side;

FIG. 3 is an external perspective view of the POS apparatus viewed from a customer side;

FIG. 4 is a block diagram of an electric configuration of the POS apparatus;

FIG. 5 is a block diagram of a hardware configuration of a cellular phone;

FIG. 6 is a diagram for explaining a procedure for installing a transaction information display program in the cellular phone;

FIG. 7A is a flowchart of a flow of commodity sales data processing performed in the POS apparatus;

FIG. 7B is a flowchart of a flow of transaction information display processing performed in the cellular phone;

FIG. 8 is a schematic diagram of an example of display on a terminal display unit of the cellular phone;

FIG. 9 is a time chart of an example of a flow of data in the commodity sales data processing system;

FIG. 10 is a schematic diagram of an overview of the commodity sales data processing system;

FIG. 11 is a flowchart of flows of an individual identification information reception processing performed in the POS apparatus and individual identification information transmission processing performed in the cellular phone;

FIG. 12A is a flowchart of a flow of commodity sales data processing performed in the POS apparatus;

FIG. 12B is a flowchart of a flow of transaction information display processing performed in the cellular phone;

FIG. 13 is a time chart of an example of a flow of data in the commodity sales data processing system;

FIG. 14 is a schematic diagram of an overview of the commodity sales data processing system;

FIG. 15A is a flowchart of a flow of individual identification information reception processing performed in the POS apparatus; and

FIG. 15B is a flowchart of a flow of individual identification information transmission processing performed in the cellular phone.

### DETAILED DESCRIPTION

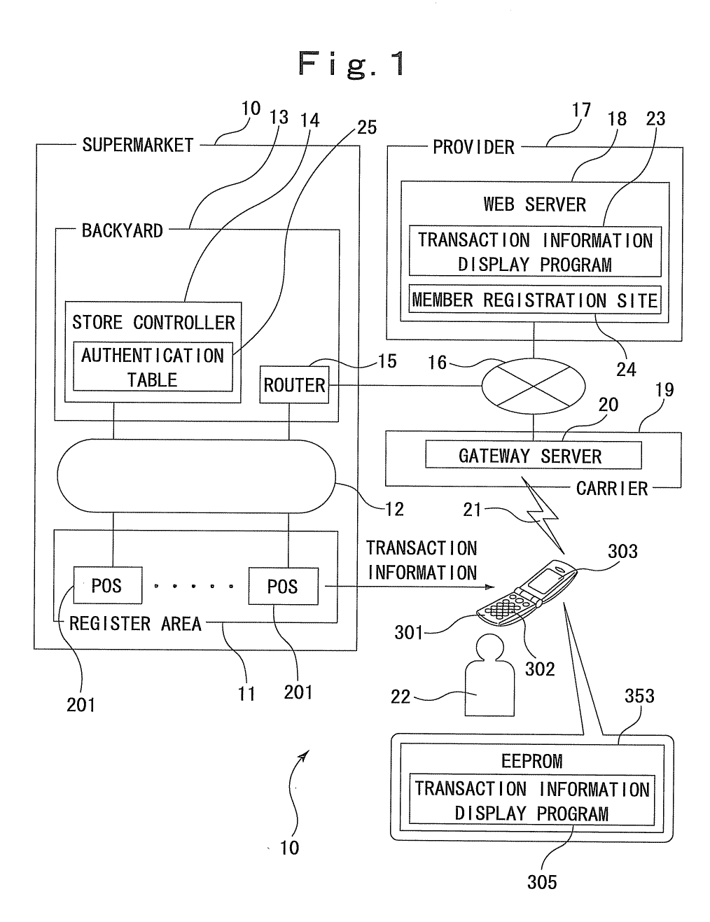

An embodiment is explained with reference to FIGS. 1 to 9.

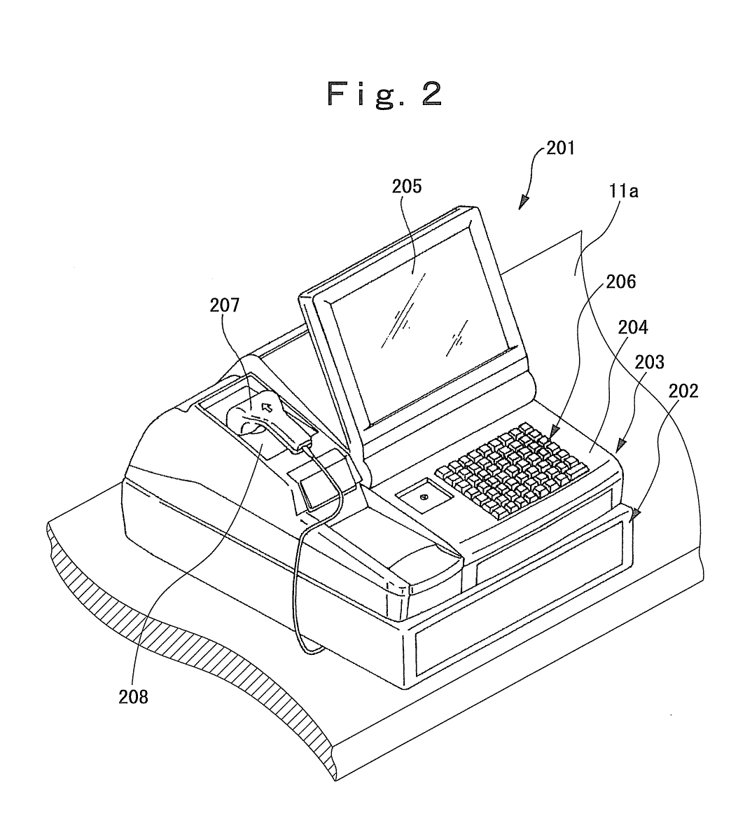

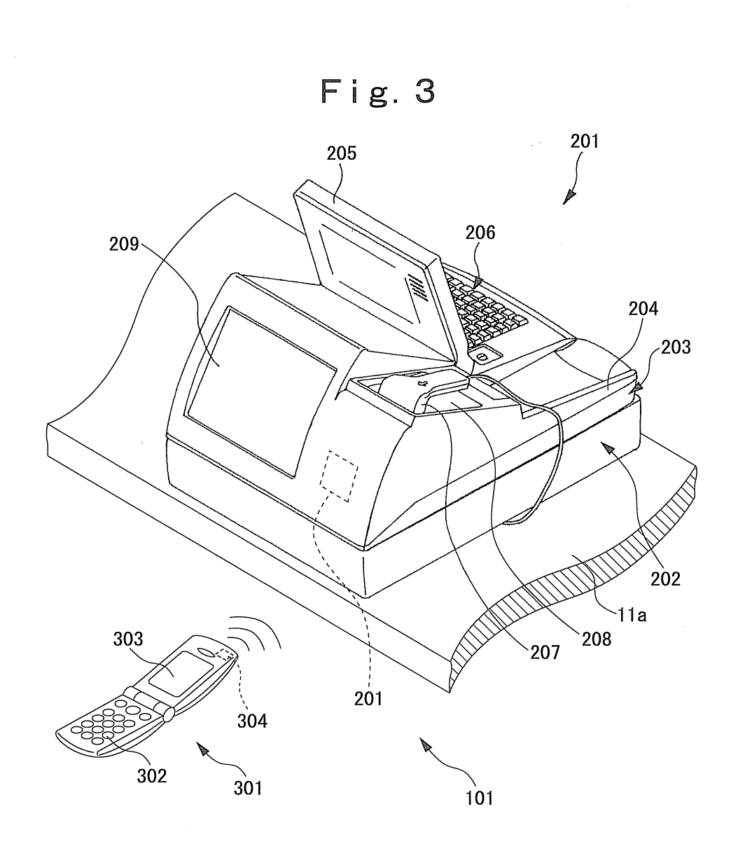

FIG. 1 is a schematic diagram of an overview of a commodity sales data processing system 101 and a wide area network including the commodity sales data processing system 101. A register area 11 is formed in a supermarket 10. The register area 11 includes a resister counter 11a (see FIGS. 2 and 3). Plural POS apparatuses 201 as commodity sales data processing apparatuses are set in the register area 11 of the supermarket 10. Each of the POS apparatuses 201 includes a radio communication unit 210 (see FIG. 3) as a first communication unit. A customer 22 carries a cellular phone 301 as a customer-carried terminal. The cellular phone 301 includes a terminal operation unit 302, a terminal display unit 303, and a radio communication unit 304 (see FIG. 3) as a second communication unit. The radio communication unit 210 executes near distance radio communication with the radio communication unit 304. The near distance radio communication is communication not via a carrier network 21. The cellular phone 301 outputs individual identification information as a terminal code. The individual identification information is unique information corresponding to each cellular phone. The POS apparatuses 201 and the cellular phone 301 configure the commodity sales data processing system 101.

A LAN network 12 is disposed in the supermarket 10. A backyard 13 is formed in the supermarket 10. The backyard 13 includes a store controller 14. The store controller 14 has an authentication table 25. In other words, the store controller 14 functions as a storing unit that stores the authentication table 25.

The POS apparatuses 201 are connected to the store controller 14 via the LAN network 12. The store controller 14 collectively manages the POS apparatuses 201 via the LAN network 12. A router 15 is connected to the LAN network 12. The store controller 14 is connected to the Internet 16 via the LAN network 12 and the router 15.

A provider 17 includes a web server 18. The web server 18 is connected to the Internet 16. The web server 18 stores a transaction information display program 23 and a member registration site 24. The web server 18 lays the member registration site 24 open to the public on the web via the Internet 16. A page source of the member registration site 24 is the HTML language including a script. The script allows a customer to perform member registration in exchange for individual identification information and predetermined personal information of the customer and download the transaction information display program 23 on the web. The transaction information display program 23 starts on the cellular phone 301. The web server 18 delivers the received individual identification information to the store controller 14 as appropriate. The store controller 14 stores the received individual identification information in the authentication table 25.

An operator inputs a URI (Uniform Resource identifier) from the terminal operation unit 302 of the cellular phone 301. The cellular phone 301 acquires data specified by the URI from the Internet 16 via the carrier network 21. The cellular phone 301 stores the acquired data. The cellular phone 301 displays the acquired data on the terminal display unit 303. Such functions of the cellular phone 301 are general functions. Therefore, explanation of the functions is omitted.

A carrier (communication carrier) 19 includes a gateway server 20. The gateway server 20 mediates data communication between the Internet 16 and the carrier network 21.

The cellular phone 301 includes an EEPROM 353. The cellular phone 301 accesses the member registration site 24 and acquires the transaction information display program 23 from the web server 18. The cellular phone 301 stores the transaction information display program 23 in the EEPROM 353. In the following explanation, the transaction information display program 23 stored in the EEPROM 353 is denoted by reference numeral “305”.

The customer 22 brings commodities, which the customer 22 plans to purchase, to the register area 11 in the supermarket 10. The customer 22 operates the cellular phone 301 and actuates the transaction information display program 305 in advance. According to the actuation, the cellular phone 301 stands by for reception of transaction information. The POS apparatus 201 transmits and outputs, every time a commodity code is input from a code scanner 207 (see FIGS. 2 to 4) as a commodity-code input unit, transaction information based on the commodity code by radio. When the cellular phone 301 receives the transaction information, the cellular phone 301 displays the transaction information on the terminal display unit 303. The customer 22 looks at the transaction information displayed on the terminal display unit 303. This allows the customer 22 to check commodities that the customer 22 purchases and check whether a store clerk (a checker) makes a mistake in commodity code scanning work. The customer 22 holds the cellular phone 301. Therefore, customers other than the customer 22 in checkout transaction cannot see the transaction information.

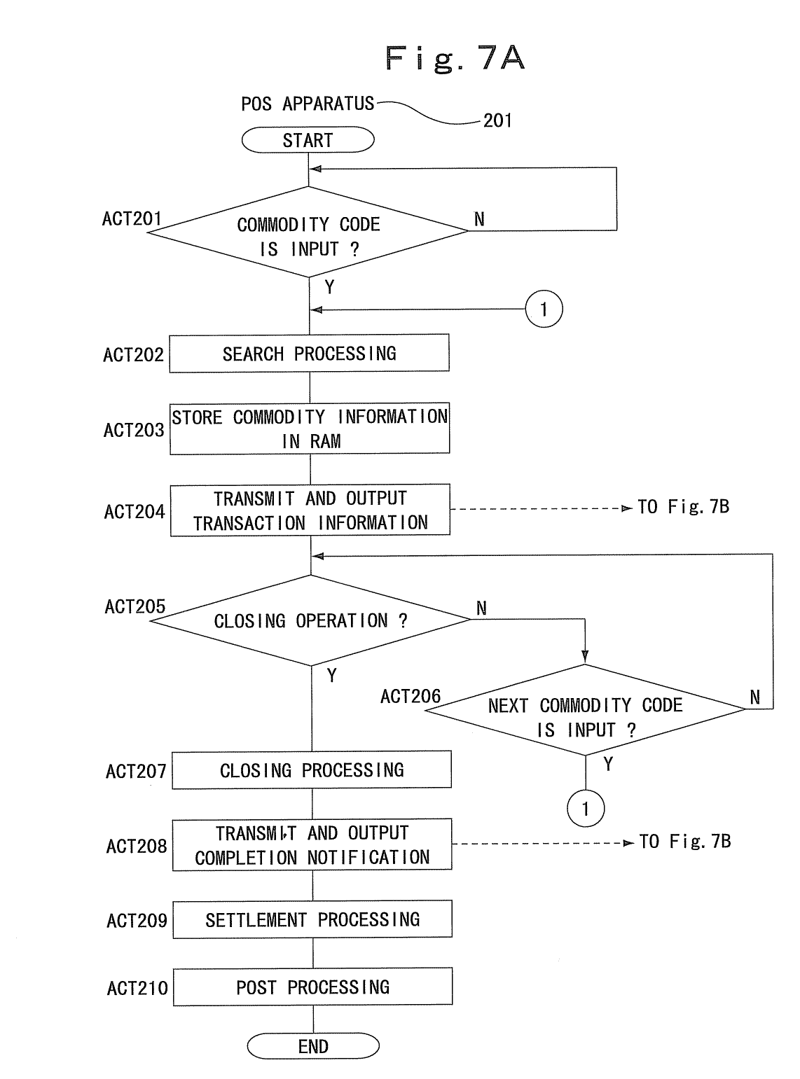

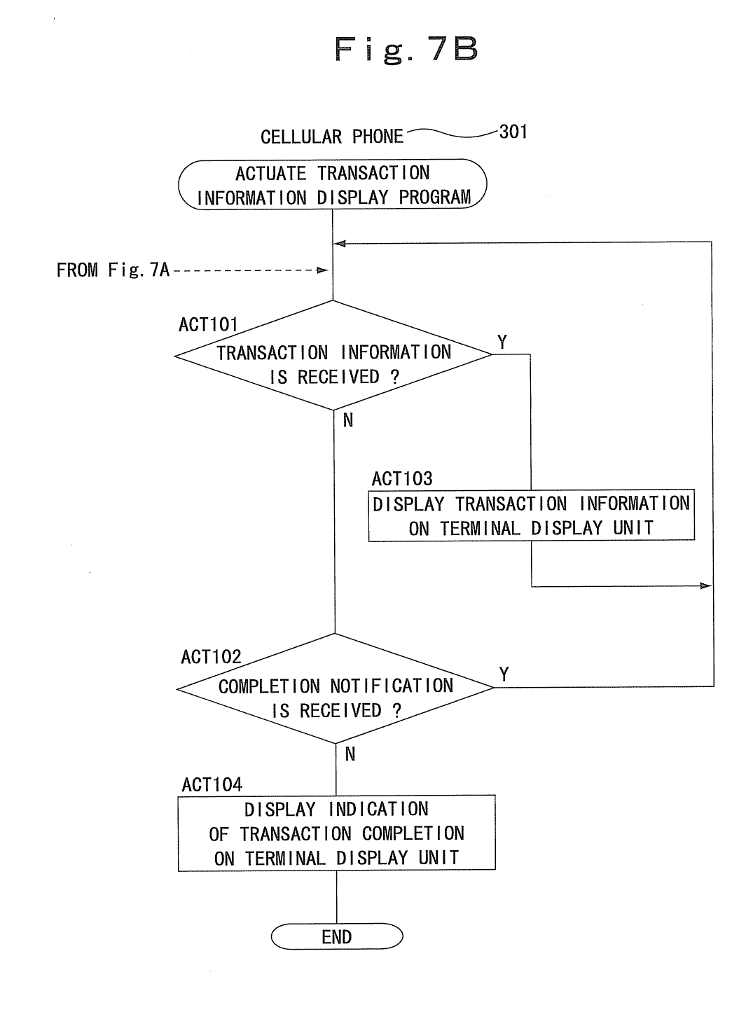

FIG. 2 is an external perspective view of the POS apparatus 201 viewed from a store clerk side. The POS apparatus 201 includes a drawer 202 and a POS terminal 203. The drawer 202 is placed on the register counter 11a. The POS terminal 203 is placed on the drawer 202. The POS terminal 203 includes a housing 204. A display for store clerk 205 is a liquid crystal display. The display for store clerk 205 is vertically provided from an upper surface of the housing 204 to the store clerk side. A keyboard 206 is located from the base of the display for store clerk 205 to the store clerk side on the upper surface of the housing 204. The keyboard 206 includes a ten key for inputting numbers, a close key, and a settlement key. The close key is a trigger for closing processing (explained later with reference to FIG. 7A). The settlement key is a trigger for settlement processing for executing settlement of a commodity price.

The POS terminal 203 includes a code scanner 207. The code scanner 207 is placed on a code-scanner placing unit 208. A gripping section of the code scanner 207 faces the store clerk side. The code-scanner placing unit 208 is located on the left side of the display for store clerk 205 on the upper surface of the housing 204. A commodity code is converted into a code symbol and attached to a commodity. The code scanner 207 optically scans the code symbol. The code scanner 207 decodes a scanned signal into the commodity code. The code scanner 207 inputs the commodity code to the POS apparatus 201.

FIG. 3 is an external perspective view of the POS apparatus 201 viewed from the customer side. A display for customer 209 is located on a surface on the customer side of the housing 204. The display for customer 209 is a liquid crystal display. A radio communication unit 210 is located in the inside of the housing 204 and further on the right side than the display for customer 209. The radio communication unit 210 performs radio wave communication with the radio communication unit 304. The cellular phone 301 includes the radio communication unit 304.

Both the radio communication units 210 and 304 conform to the Bluetooth standard. Both the radio communication unit 210 and 304 perform near distance radio communication using a radio wave in a 2.4 GHz frequency band. In general, a communicatable range of the near distance radio communication by the Bluetooth standard is about 10 to 100 meters. The communicatable range changes according to output intensity of a radio wave. A space area in which the near distance radio communication is possible is limited to the vicinity of the POS apparatus 201 according to adjustment of output intensity of a radio wave from the POS apparatus 201. A person who sets the commodity sales data processing system 101 adjusts output intensity of a radio wave in advance such that only the cellular phone 301 carried by the customer 22 in checkout transaction can perform the near distance radio communication with the POS apparatus 201.

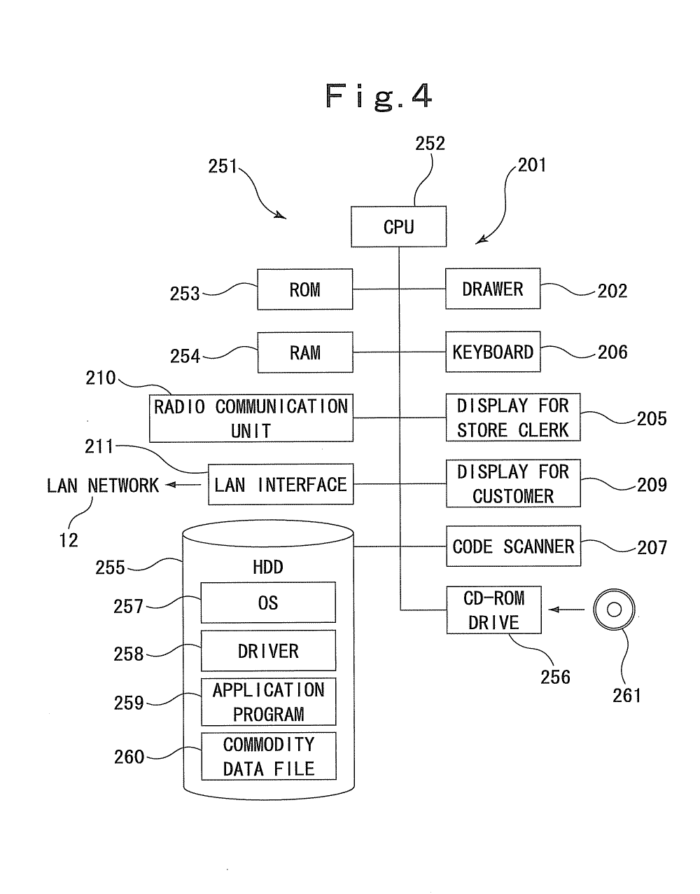

FIG. 4 is a block diagram of an electric configuration of the POS apparatus 201. The POS apparatus 201 includes a first information processing unit 251 that executes information processing. The first information processing unit 251 includes a CPU 252, a ROM 253, and a RAM 254. The CPU 252 is connected to the drawer 202, the keyboard 206, the display for store clerk 205, the display for customer 209, the code scanner 207, the radio communication unit 210, and a LAN interface 211 via an input and output circuit (not shown in the figure) and controls the same. The CPU 252 is also connected to an HDD 255 and a CD-ROM drive 256.

The HDD 255 stores various programs and data files including an OS 257, a driver 258, various application programs 259, and a commodity data file 260. The application programs 259 include a commodity sales data processing program for realizing commodity sales data processing (see FIG. 7A) executed by the CPU 252. The commodity data file 260 stores commodity codes for specifying commodities and commodity information such as commodity names, categories to which the commodities belong, commodity unit prices, and discount information in association with each other.

The setting person installs the programs and data in the HDD 255 from a CD-ROM medium 261 via the CD-ROM drive 256.

As another example, the setting person operates the POS apparatus 201 to download an update program from the store controller 14. In order to install the programs and data in the HDD 255, the setting person causes the CPU 252 to execute the update program.

When the POS apparatus 201 is actuated, the CPU 252 reads the various programs and data files such as the OS 257, the driver 258, the various application programs 259, and the commodity data file 260 in the RAM 254. The CPU 252 executes processing according to described contents of the programs read in the RAM 254.

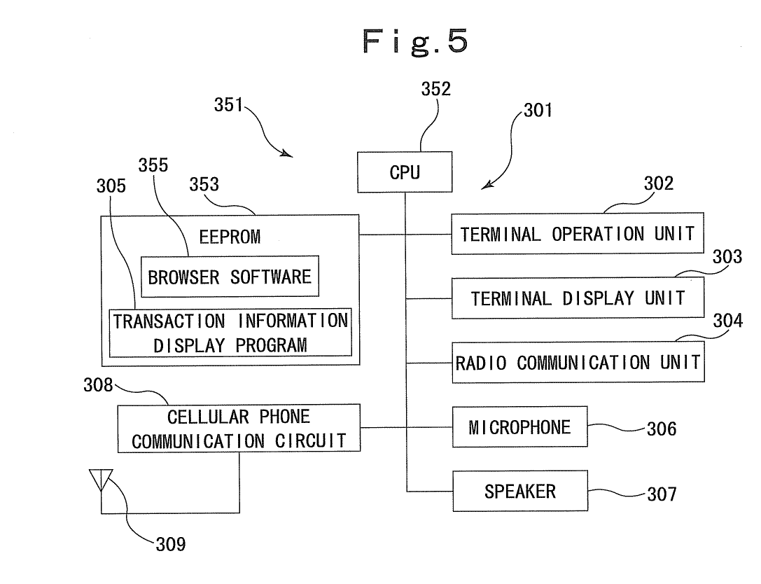

FIG. 5 is a block diagram of a hardware configuration of the cellular phone 301. The cellular phone 301 incorporates a microcomputer 351 as a second information processing unit. The microcomputer 351 includes a CPU 352 and an EEPROM 353. The EEPROM 353 stores individual identification information as terminal codes for specifying individual cellular phones 301. The CPU 352 is connected to the terminal operation unit 302, the terminal display unit 303, the radio communication unit 304, a microphone 306, a speaker 307, and a cellular phone communication circuit 308 via an input and output circuit (not shown in the figure) and controls the same. The control performed by the CPU 352 conforms to the description of the various programs stored in the EEPROM 353. The cellular phone communication circuit 308 is connected to an antenna 309. The antenna 309 transmits and receives a radio wave to and from the carrier network 21.

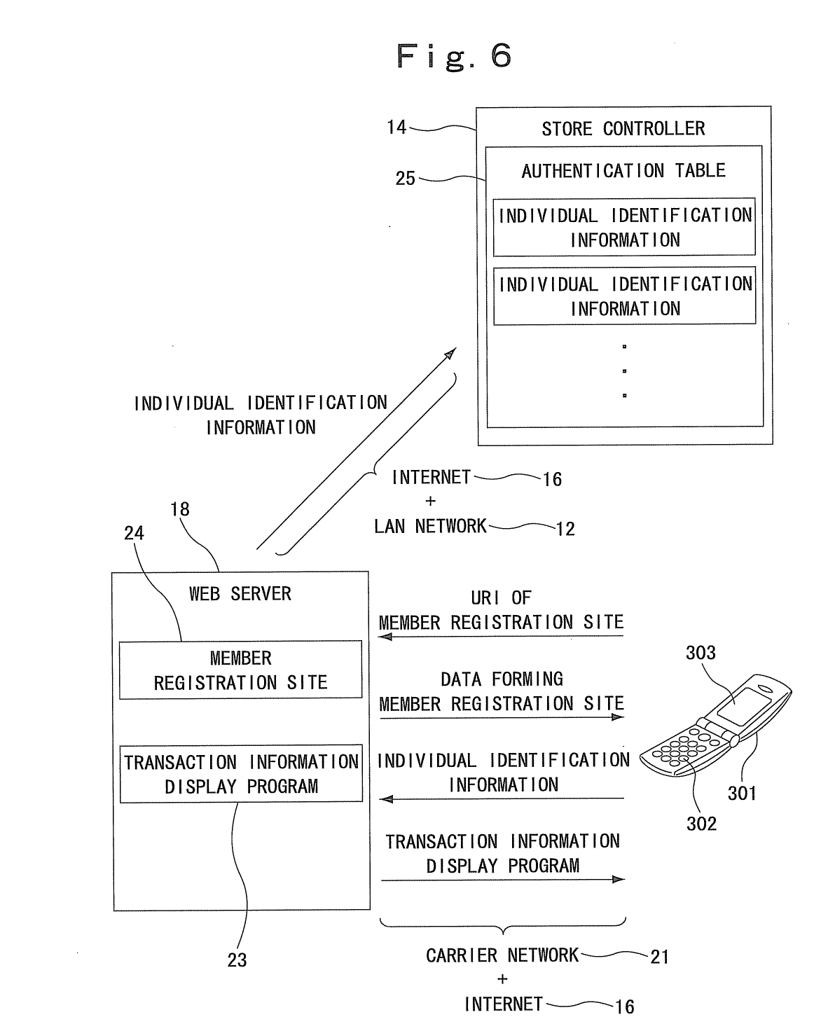

The EEPROM 353 stores various programs including browser software 355. The CPU 352 accesses, according to the browser software 355, data on the Internet 16 specified by a URI designated and input from the terminal control unit 302. The CPU 352 interprets the accessed data using the HTTP protocol. The CPU 352 displays the interpreted data on the terminal display unit 303 or stores the interpreted data in the EEPROM 353. The EEPROM 353 also stores the transaction information display program 305 installed in the procedure shown in FIG. 6.

FIG. 6 is a diagram for explaining a procedure for installing the transaction information display program 305 in the cellular phone 301. The customer 22 operates the terminal operation unit 302 while looking at the terminal display unit 303 of the cellular phone 301 and actuates the browser software 355. Subsequently, the customer 22 designates and inputs a URI (Uniform Resource Identifier) for specifying the member registration site 24 from the terminal operation unit 302. The cellular phone 301 accesses the member registration site 24. The web server 18 transmits data included in the member registration site 24 to the cellular phone 301 at a transmission source of the URI. The cellular phone 301 displays the member registration site 24 on the terminal display unit 303 on the basis of the data transmitted by the web server 18. The member registration site 24 includes a download button, a message, and a form for inputting personal information such as a name, an address, sex, and age of the customer 22 (all of which are not shown in the figure). The message indicates that the individual identification information of the cellular phone 301 is transmitted to the web server 18 and the transaction information display program 23 is downloaded to the cellular hone 301 according to the selection of the download button. The customer 22 operates the terminal operation unit 302 to designate the download button. According to the designation, the cellular phone 301 starts download of the transaction information display program 23. The customer 22 operates the terminal operation unit 302 of the cellular phone 301 while looking at the terminal display unit 303 and selects the download button in a state in which personal information is input in the form. According to the selection of the download button, the cellular phone 301 transmits the individual identification information to the web server 18. When the web server 18 receives the individual identification information of the cellular phone 301 and data of the personal information input to the form, the web server 18 transmits the transaction information display program 23 to the cellular phone 301 at the transmission source of the individual identification information. When the cellular phone 301 receives the transaction information display program 23, the cellular phone 301 stores the transaction information display program 23 in the EEPROM 353. The cellular phone 301 performs the data communication with the web server 18 via the carrier network 21 and the Internet 16.

The web server 18 stores the individual identification information and the data of the personal information transmitted from the cellular phone 301. The web server 18 delivers the individual identification information and the data of the personal information to store controllers 14 of supermarkets 10. The web server 18 performs the delivery at predetermined time intervals or in response to a data transmission request from the store controller 14. When the store controller 14 receives the individual identification information, the store controller 14 stores the individual identification information in the authentication table 25. When the store controller 14 receives the data of the personal information, the store controller 14 stores the data of the personal information in a personal information data table (not shown in the figure) in the store controller 14. The web server 18 performs the data communication with the store controller 14 via the Internet 16 and the LAN network 12.

FIG. 7A is a flowchart of a flow of commodity sales data processing performed in the POS apparatus 201. The CPU 252 of the POS apparatus 201 starts the commodity sales data processing during the actuation of the POS apparatus 201. The flow of the commodity sales data processing conforms to the description of the commodity sales data processing program included in the application programs 259.

When the CPU 252 starts the commodity sales data processing, the CPU 252 stands by for the input of a commodity code from the code scanner 207 (Act 201).

The CPU 252 determines that a commodity code is input from the code scanner 207 (Y in Act 201), the CPU 252 executes search processing (Act 202). The search processing is processing for searching through the commodity data file 260 (see FIG. 4) and acquiring commodity information corresponding to the input commodity code.

Subsequently, the CPU 252 stores the acquired commodity information in the RAM 254 (Act 203).

The CPU 252 causes the radio communication unit 210 to transmit and output transaction information (Act 204). What is important is that the CPU 252 causes the radio communication unit 210 to transmit and output the transaction information without performing processing for causing the display for customer 209 to display the transaction information.

The CPU 252 stands by for any one of the depression of the closing key of the keyboard 206 and the input of the next commodity code from the code scanner 207 (Act 205 and Act 206). When the CPU 252 determines that the next commodity code is input (Y in Act 206), the CPU 252 returns the processing to Act 202. When the CPU 252 determines that the closing key is depressed (Y in Act 205), the CPU 252 executes the closing processing (Act 207). The closing processing is processing for suspending the input of the commodity code, deciding purchase planned commodities of the customer 22, and calculating a subtotal amount of the commodities.

Following the closing processing (Act 207), the CPU 252 causes the radio communication unit 210 to transmit and output completion notification and the subtotal amount (Act 208). The completion notification is information indicating that the input of commodity codes is completed. The CPU 252 calculates the subtotal amount in the closing processing (Act 207).

Following Act 208, the CPU 252 executes settlement processing for a payment amount (Act 209).

The CPU 252 executes post-processing such as printing and issuance of a receipt and transmission of a sales record to the store controller 14 (Act 210). Upon finishing this processing, the CPU 252 finishes the series of commodity sales data processing.

FIG. 7B is a flowchart of a flow of transaction information display processing performed in the cellular phone 301. In checkout of commodities in the resister area 11, the customer 22 operates the terminal operation unit 302 of the cellular phone 301 to actuate the transaction information display program 305 in advance. According to the actuation, the CPU 352 of the cellular phone 301 starts the transaction information display processing. The flow of the transaction information display processing conforms to the description of the transaction information display program 305.

When the CPU 352 of the cellular phone 301 starts the transaction information display processing, the CPU 352 stays on standby until the radio communication unit 304 receives any one of transaction information and completion notification from the POS apparatus 201 (Act 101 an Act 102).

When the radio communication unit 304 receives the transaction information (Y in Act 101), the CPU 352 causes the terminal display unit 303 to display the transaction information (Act 103). Subsequently, the CPU 352 returns the processing to Act 101.

When the radio communication unit 304 receives the completion notification (Y in Act 102), the CPU 352 causes the terminal display unit 303 to display indication that the transaction is completed (Act 104). Upon finishing this processing, the CPU 352 finishes the transaction information display processing.

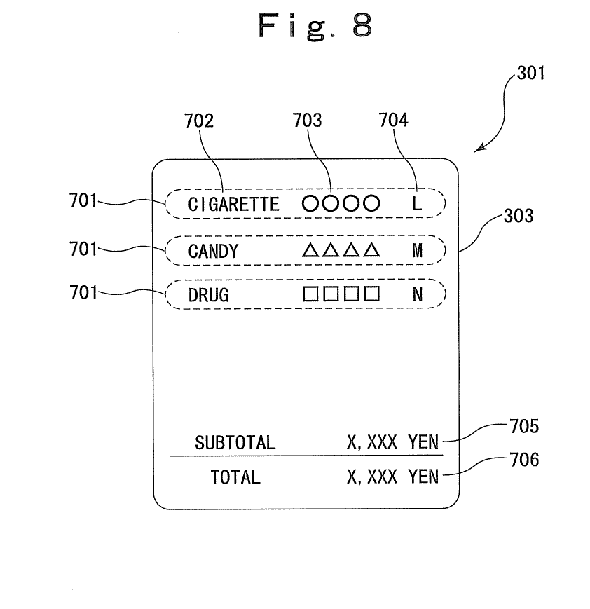

FIG. 8 is a schematic diagram of an example of display on the terminal display unit 303 of the cellular phone 301. In FIG. 8, the terminal display unit 303 displays transaction information 701 for three rows. The transaction information 701 is a horizontally-written character string for one row including a category 702 of a commodity, a commodity name 703, and the number of pieces of the commodity 704. The CPU 352 of the cellular phone 301 displays the transaction information 701 row by row in order from the top of the terminal display unit 303 every time the CPU 352 performs the processing indicated by Act 103 (see FIG. 7B)

The terminal display unit 303 displays a subtotal amount 705 and a total amount 706 in a lower part thereof. Specifically, when the CPU 352 of the cellular phone 301 receives the subtotal amount 705 from the POS apparatus 201 together with the completion notification, the CPU 352 displays the subtotal amount 705 in the lower part of the terminal display unit 303. The CPU 352 calculates the total amount 706 by adding a tax rate calculation of a consumption tax and the like to the subtotal amount 705. The CPU 352 displays the total amount 706 below the subtotal amount 705 in the lower part of the terminal display unit 303.

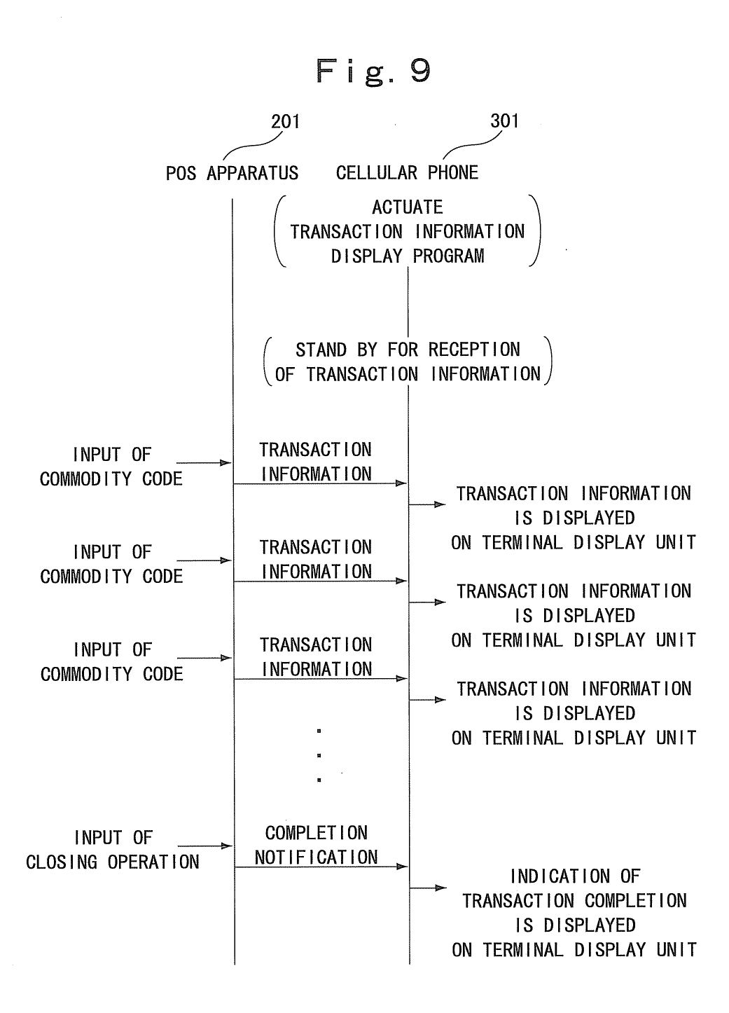

FIG. 9 is a time chart of an example of a flow of data in the commodity sales data processing system 101. When the customer 22 performs checkout transaction for commodities planned to be purchased, the customer 22 stands near the POS apparatus 201. The customer 22 operates the cellular phone 301, in which the transaction information display program 305 is installed, to actuate the transaction information display program 305. According to the actuation, the cellular phone 301 stands by for reception of transaction information from the POS apparatus 201.

When a store clerk (a cashier) performs scanning of a commodity code using the code scanner 207, the radio communication unit 210 of the POS apparatus 201 transmits and outputs transaction information based on the input commodity code. The display for customer 209 does not display the transaction information. When the radio communication unit 304 receives the transaction information, the cellular phone 301 displays the transaction information on the terminal display unit 303.

When the store clerk (the cashier) depresses the closing key of the keyboard 206 of the POS apparatus 201, the radio communication unit 210 of the POS apparatus 201 transmits and outputs completion notification. When the radio communication unit 304 receives the completion notification, the cellular phone 301 causes the terminal display unit 303 to display indication that the transaction is completed. The customer 22 can operate the terminal operation unit 302 to store the transaction information received by the cellular phone 301 in the EEPROM 353 using a data storage function of the cellular phone 301. The customer 22 can also transmit the transaction information as an electronic mail using a mail transmission function of the cellular phone 301.

The commodity sales data processing system 101 displays the transaction information on the terminal display unit 303 of the cellular phone 301. The customer 22 in checkout transaction can check, looking at the terminal display unit 303, commodities that the customer 22 purchases and check whether the store clerk (the checker) makes a mistake in commodity code scanning work. The display for customer 209 does not display the transaction information. Therefore, customers other than the customer 22 in checkout transaction cannot see the transaction information.

A system of the near distance radio communication of the commodity sales data processing system 101 may be infrared radio communication by the IrDA standard or wireless LAN connection by Wi-Fi instead of radio wave communication by the Bluetooth standard.

In the case of the infrared radio communication, the POS apparatus 201 needs to include an infrared communication port. The infrared communication port is attached to a section for outputting an infrared signal to the customer side. In this case, the customer 22 locates the cellular phone 301 in a position near the POS apparatus 201 where the infrared signal (a radio signal) transmitted and output by the infrared communication port can be received. Consequently, the cellular phone 301 performs the near distance radio communication with the POS apparatus 201.

In the case of the radio wave communication and the radio LAN connection, a space range in which the radio signal can be received is larger than that in the case of the infrared radio communication. In this case, the customer 22 locates the cellular phone 301 near the POS apparatus 201. Consequently, the POS apparatus 201 and the cellular phone 301 execute the near distance radio communication.

A modification 1 of the commodity sales data processing system 101 is explained. In the commodity sales data processing system 101 in the modification 1, the CPU 252 of the POS apparatus 201 causes the display for customer 209 to scroll-display a message “checkout information is currently displayed on your cellular phone”. The CPU 252 performs this processing while the radio communication unit 210 transmits and outputs the transaction information (Act 204 in FIG. 7A).

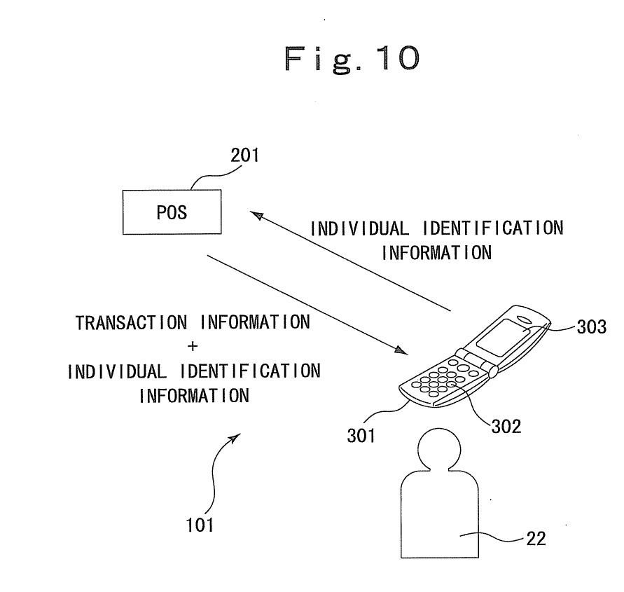

A modification 2 of the commodity sales data processing system 101 is explained with reference to FIGS. 10 to 13. In this case, components same as those of the commodity sales data processing system explained above are denoted by the same reference numerals and signs and explanation of the components is omitted. In the commodity sales data processing system 101 in the modification 2, when plural cellular phones 301 are present in a space range in which a radio signal from the POS apparatus 201 can be received, only one cellular phone 301 displays transaction information.

FIG. 10 is a schematic diagram of an overview of the commodity sales data processing system 101. The customer 22 operates the terminal operation unit 302 of the cellular phone 301 immediately before checkout transaction. According to the operation, the cellular phone 301 transmits and outputs individual identification information. When the POS apparatus 201 receives the individual identification information, the POS apparatus 201 causes the radio communication unit 210 (see FIGS. 3 and 4) to transmit and output the received individual identification information together with the transaction information. The radio communication unit 304 (see FIGS. 3 and 5) of the cellular phone 301 receives the transaction information and the individual identification information. The cellular phone 301 determines whether the individual identification information stored in the EEPROM 353 (see FIG. 5) and the received individual identification information coincide with each other. Only when both the kinds of individual identification information coincide with each other, the cellular phone 301 displays the received transaction information on the terminal display unit 303. Therefore, the transaction information appears only on the cellular phone 301 carried by the customer 22 who is performing the checkout transaction and does not appear on other cellular phones.

When the POS apparatus 201 does not receive the individual identification information, the POS apparatus 201 does not transmit and output the transaction information by radio and displays the transaction information on the display for customer 209 (see FIGS. 3 and 4). Therefore, when the customer 22 does not have the cellular phone 301, the customer 22 can see the transaction information displayed on the display for customer 209 (see FIGS. 3 and 4).

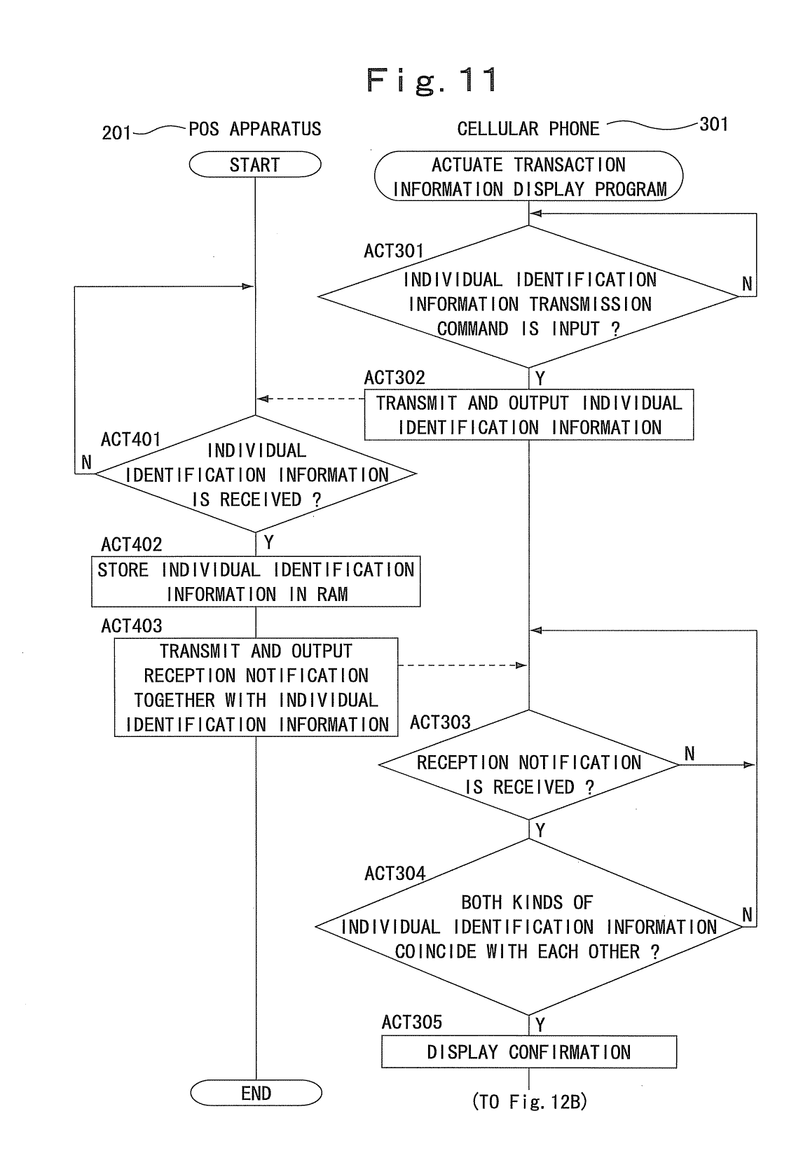

The application programs 259 (see FIG. 4) includes an individual identification information receiving program (not shown in the figure) that describes processing content of individual identification information reception processing shown in FIG. 11. The transaction information display program 305 (see FIG. 5) includes processing content of individual identification information transmission processing shown in FIG. 11.

FIG. 11 is a flowchart of flows of the individual identification information reception processing performed in the POS apparatus 201 and the individual identification information transmission processing performed in the cellular phone 301. The CPU 252 of the POS apparatus 201 actuates the individual identification information receiving program (not shown in the figure) during the actuation of the POS apparatus 201. According to the actuation, the CPU 252 stands by for the radio communication unit 210 to receive individual identification information transmitted from the cellular phone 301 (Act 401). When the CPU 252 determines that the radio communication unit 210 receives the individual identification information (Y in Act 401), the CPU 252 stores the received individual identification information in the RAM 254 (Act 402).

Subsequently, the CPU 252 transmits and outputs reception notification to the radio communication unit 210 together with the received individual identification information (Act 403). Upon finishing this processing, the CPU 252 finishes the series of individual identification information reception processing.

The customer 22 performs operation input for designating actuation of the transaction information display program 305 from the terminal operation unit 302 of the cellular phone 301. According to this operation, the CPU 352 of the cellular phone 301 starts transaction information display processing. The CPU 352 determines whether operation input for transmitting and outputting individual identification information is performed from the terminal operation unit 302 (Act 301). When the operation input is performed (Y in Act 301), the CPU 352 causes the radio communication unit 304 to transmit and output the individual identification information stored in the EEPROM 353 (Act 302).

As processing following Act 302, the CPU 352 stands by for the radio communication unit 304 to receive reception notification transmitted and output from the POS apparatus 201 (Act 303). When the radio communication unit 304 receives the reception notification (Y in Act 303), the CPU 352 performs processing in Act 304.

In Act 304, the CPU 352 determined whether individual identification information received together with the reception notification and the individual identification information stored in the EEPROM 353 coincide with each other (Act 304). Only when both the kinds of individual identification information coincide with each other (Y in Act 304), the CPU 352 causes the terminal display unit 303 to display confirmation indication (Act 305). The confirmation indication is indication that the individual identification information is received by the POS apparatus 201. Upon finishing the processing in Act 305, the CPU 352 finishes the series of individual identification information transmission processing.

On the other hand, when both the kinds of individual identification information do not coincide with each other in Act 304 (N in Act 304), the CPU 352 returns the processing to Act 303.

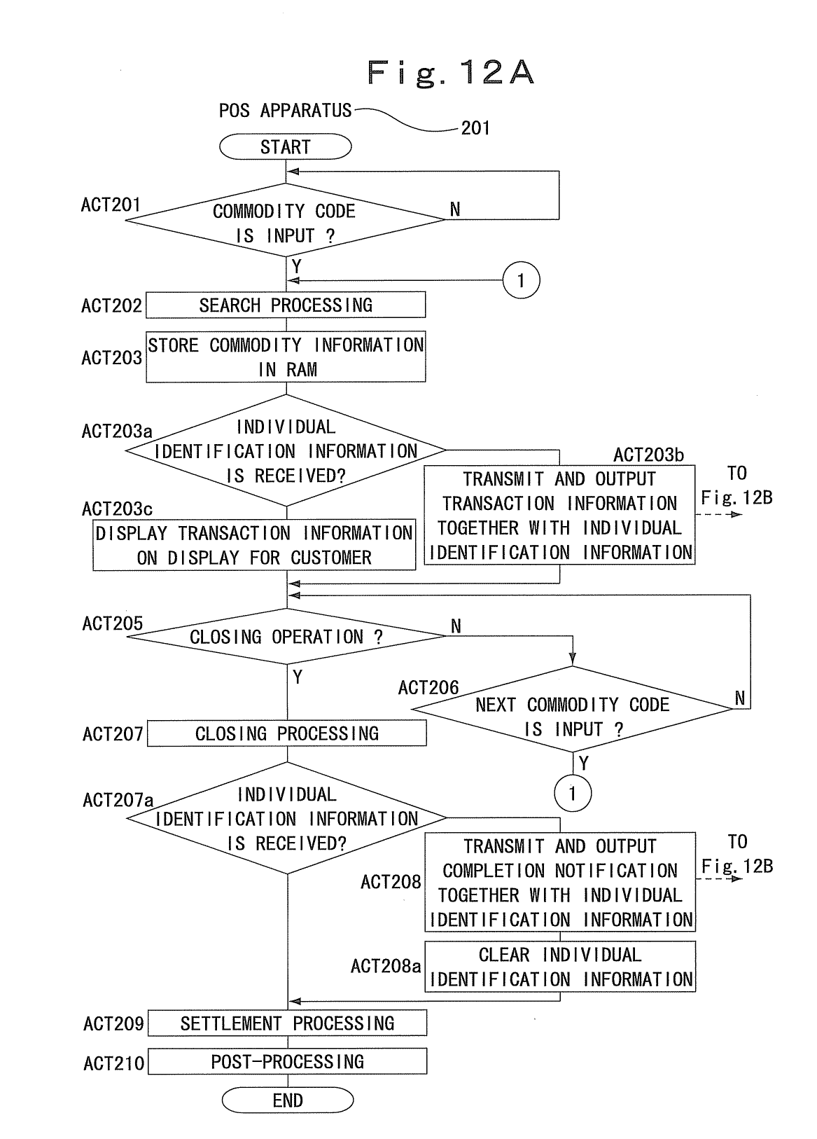

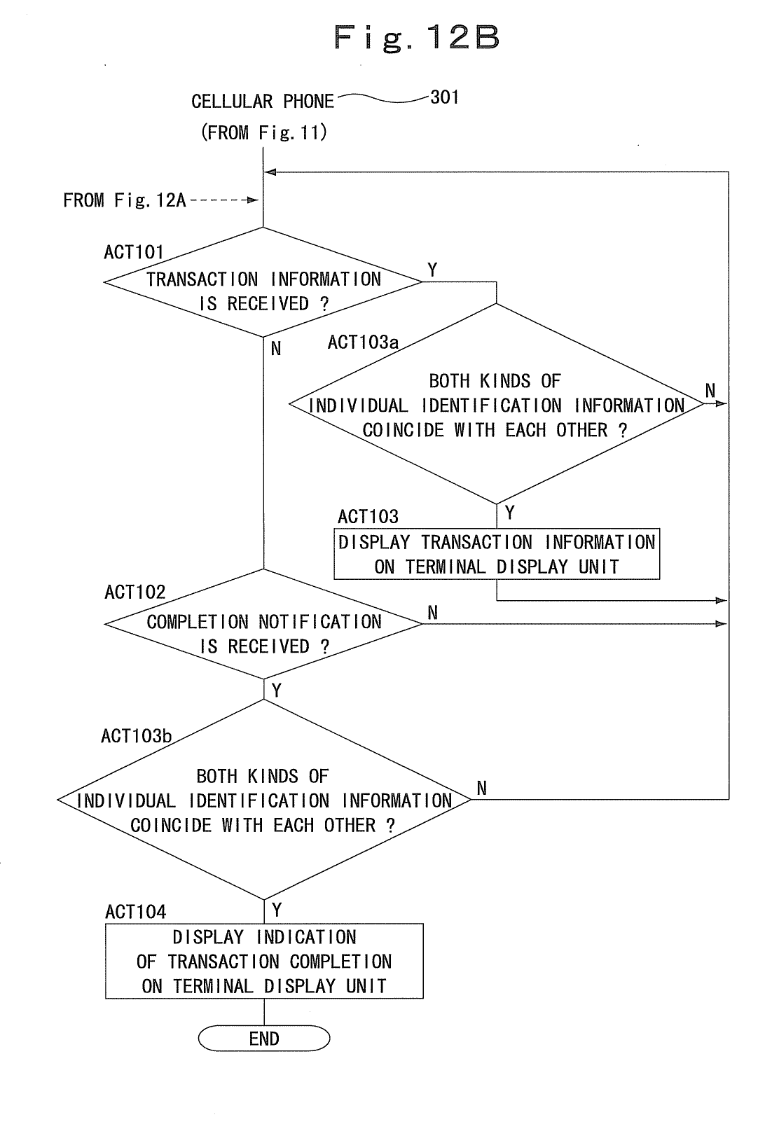

FIG. 12A is a flowchart of a flow of commodity sales data processing performed in the POS apparatus 201. The CPU 252 of the POS apparatus 201 determines whether the RAM 254 stores individual identification information between Act 203 and Act 205 (Act 203a). Only when the RAM 254 stores the individual identification information (Y in Act 203a), the CPU 252 causes the radio communication unit 210 to transmit and output the individual identification information together transaction information (Act 203b). On the other hand, when the RAM 254 does not store the individual identification information in Act 203a (N in Act 203a), the CPU 252 causes the display for customer 209 to display the transaction information (Act 203c ). After Act 203b or Act 203c, the CPU 252 advances the processing to Act 205. In this embodiment, in the POS apparatus 201, according to whether the individual identification from the cellular phone 301 is received, the display for customer 209 displays the transaction information or the radio communication unit 210 transmits and outputs the transaction information.

The CPU 252 determines whether the RAM 254 stores the individual identification information between closing processing (Act 207) and settlement processing (Act 209) (Act 207a) Only when the RAM 254 stores the individual identification information (Y in Act 207a), the CPU 252 causes the radio communication unit 210 to transmit and output completion notification and the individual identification information (Act 208). Following Act 208, the CPU 252 clears the individual identification information stored in the RAM 254 (Act 208a). Thereafter, the CPU 252 advances the processing to Act 209.

FIG. 12B is a flowchart of a flow of transaction information display processing performed in the cellular phone 301. In this modification, following Y in Act 101, the CPU 352 of the cellular phone 301 determines whether the individual identification information received by the radio communication unit 304 and the individual identification information stored in the EEPROM 353 coincide with each other (Act 103a). When both the kinds of individual identification information coincide with each other (Y in Act 103a), the CPU 352 displays the transaction information on the terminal display unit 303 (Act 103) and returns the processing to Act 101. On the other hand, when both the kinds of individual identification information do not coincide with each other (N in Act 103a), the CPU 352 returns the processing to Act 101 without performing the processing in Act 103. The CPU 352 executes processing same as Act 103a when the completion notification is received in the cellular phone 301 (Y in Act 102) (Act 103b). When both the kinds of individual identification information coincide with each other in Act 103b (Y in Act 103b), the CPU 352 advances the processing to Act 104. On the other hand, when both the kinds of individual identification information do not coincide with each other in Act 103b (N in Act 103b), the CPU 352 returns the processing to Act 101.

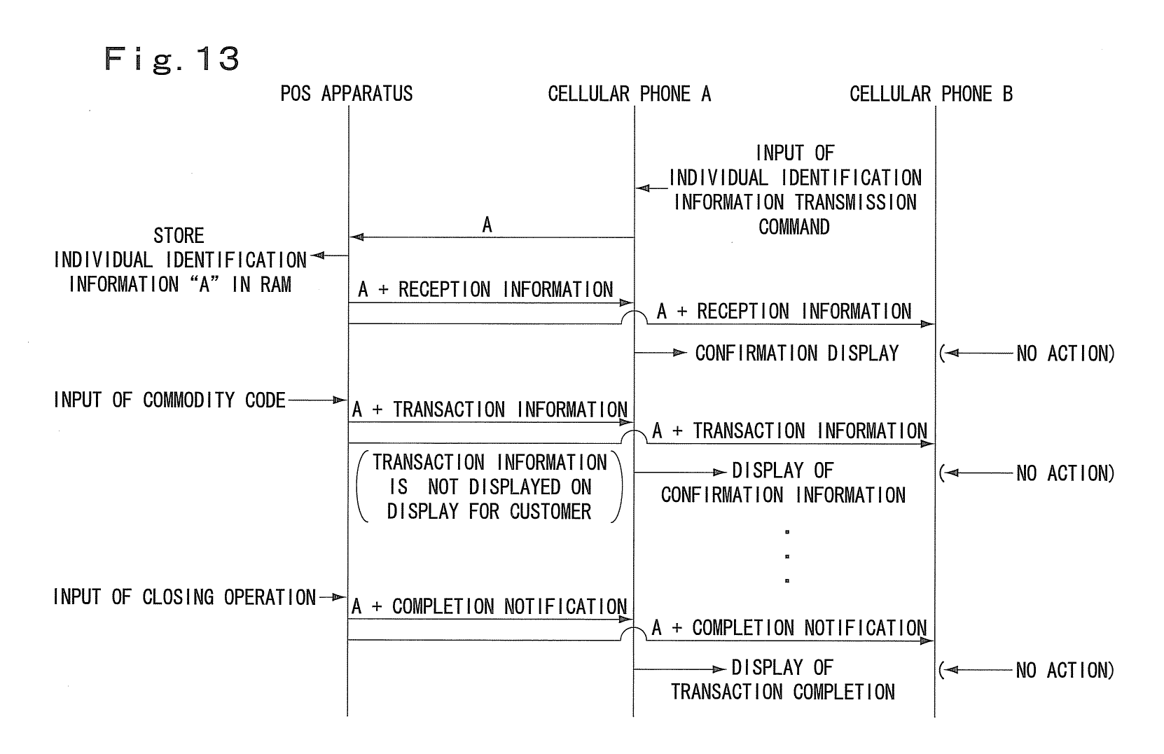

FIG. 13 is a time chart of an example of a flow of data in the commodity sales data processing system 101. In this modification, usually, the display for customer 209 displays transaction information based on a commodity code input from the code scanner 207. Therefore, the customer 22 can check commodities, which the customer 22 intends to purchase, looking at the display for customer 209 even if the customer 22 does not have the cellular phone 301.

It is assumed that a cellular phone A transmits and outputs individual identification information. In this case, when the POS apparatus 201 receives the individual identification information of the cellular phone A, the POS apparatus 201 stores the individual identification information in the RAM 254. The POS apparatus 201 transmits and outputs the individual identification information and transaction information by radio without displaying the transaction information on the display for customer 209. Cellular phones A and B that actuate the transaction information display program 305 do not display confirmation indication, indication of transaction information, and transaction completion unless the cellular phones A and B receive individual identification information that coincides with individual identification information of the cellular phones A and B. Therefore, the terminal display unit 303 of the cellular phone A displays the confirmation indication, the indication of transaction information, and the transaction completion. On the other hand, the terminal display unit 303 of the cellular phone B does not display the same.

In the commodity sales data processing system 101 according to this modification, only the terminal display unit 303 of one cellular phone 301 displays the transaction information. The terminal display units 303 of the other cellular phones 301 do not display the transaction information and the like. In starting checkout transaction, the store clerk (the cashier) proposes the customer 22 to perform operation for transmitting and outputting individual identification information. The customer 22 performs the operation for transmitting and outputting the individual identification information from the cellular phone 301. The terminal display unit 303 of the cellular phone 301 of the customer 22 displays the transaction information.

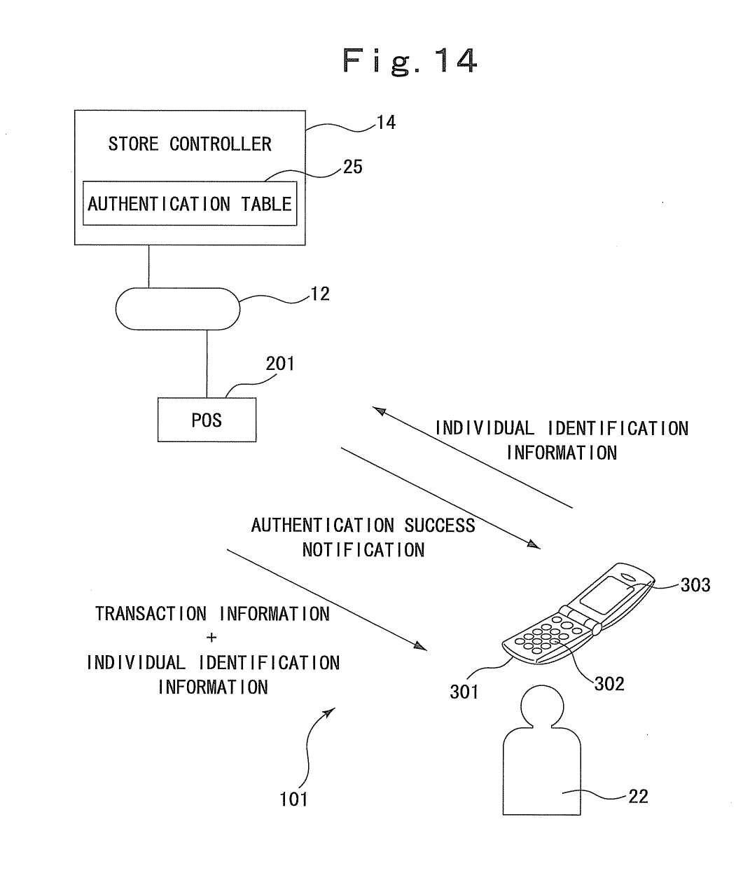

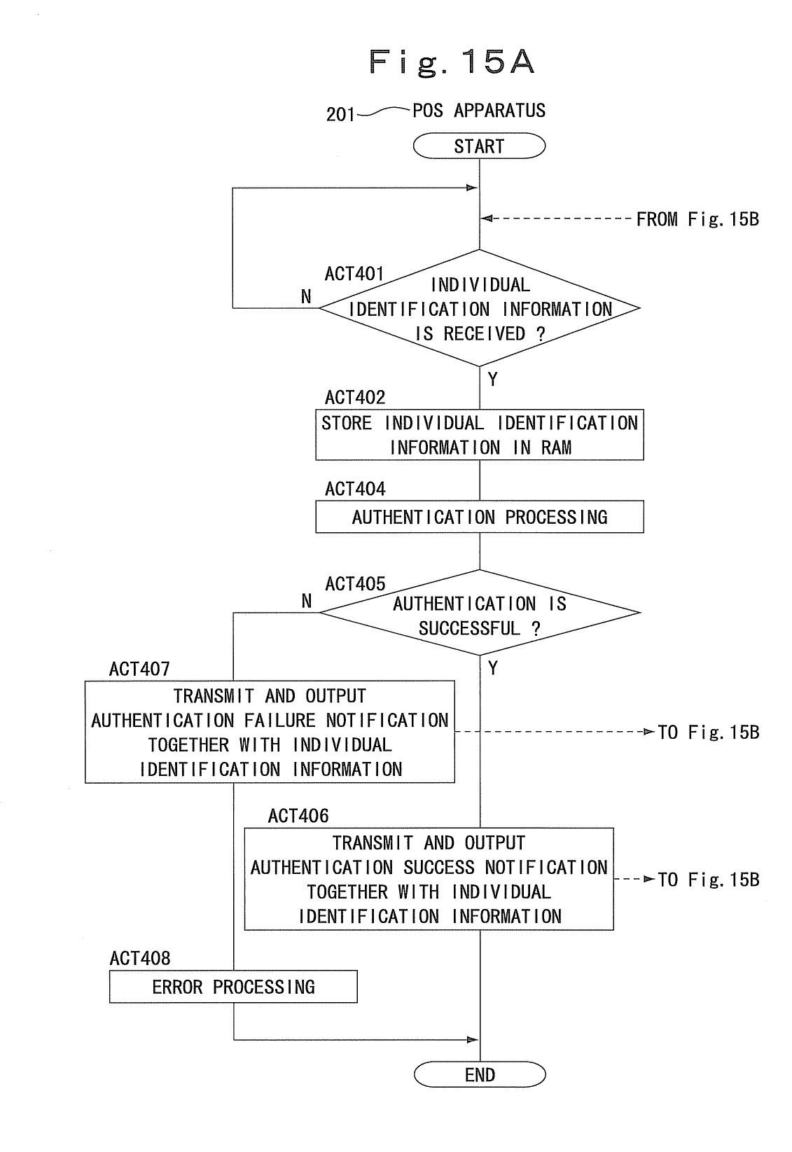

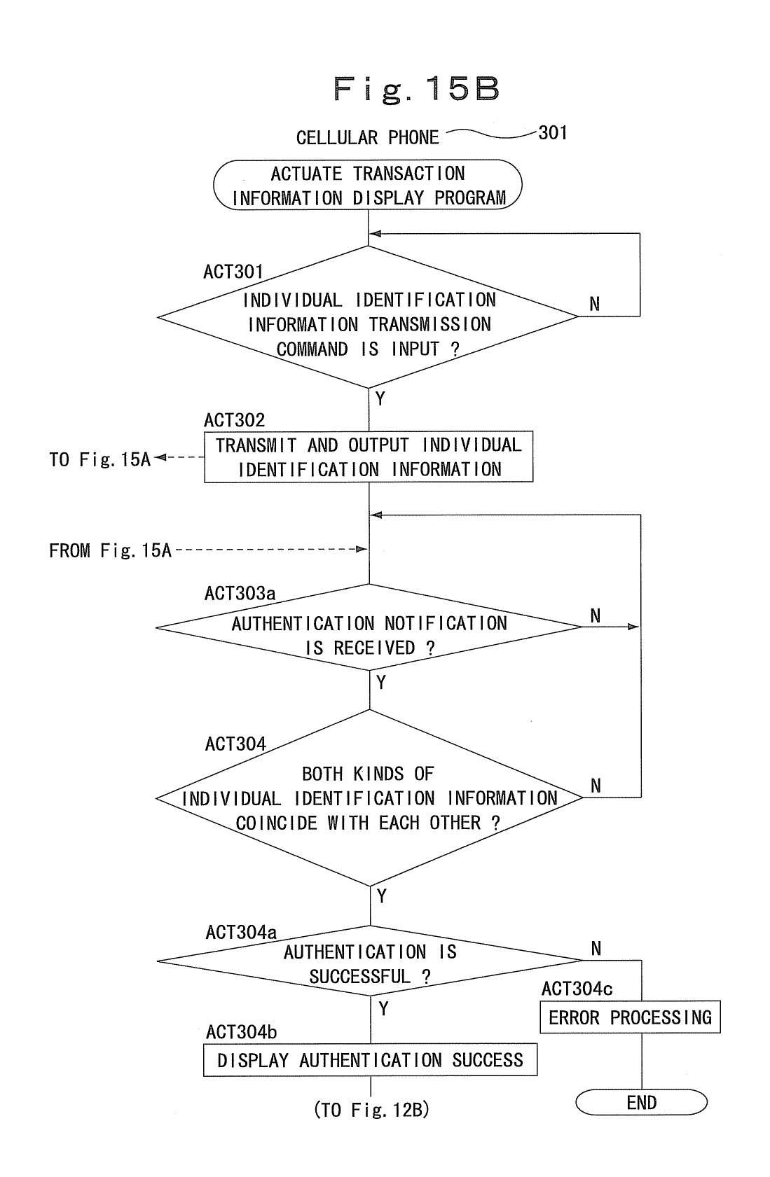

A modification 3 of the commodity sales data processing system 101 is explained with reference to FIG. 14 and FIGS. 15A and 15B. The modification 3 is a modification to the modification 2. In this case, components same as those of the commodity sales data processing system 101 explained above are denoted by the same reference numerals and signs and explanation of the components is omitted.

FIG. 14 is a schematic diagram of an overview of the commodity sales data processing system 101. The POS apparatus 201 determines, on the basis of received individual identification information, whether the cellular phone 301 that is about to display transaction information can display the transaction information. The POS apparatus 201 transmits and outputs the transaction information by radio only when the POS apparatus 201 determines that the transaction information display program 305 is stored in the cellular phone 301 and the cellular phone 301 can receive the transaction information.

FIG. 15A is a flowchart of a flow of individual identification information reception processing performed in the POS apparatus 201. In this modification, after executing Act 402, the CPU 252 of the POS apparatus 201 executes authentication processing (Act 404).

In the authentication processing, the CPU 252 of the POS apparatus 201 causes the radio communication unit 210 to transmit the individual identification information to the store controller 14. The individual identification information is that received by the radio communication unit 210. A CPU (not shown in the figure) of a store computer returns a determination result concerning whether the received individual identification information is included in the authentication table 25 to the POS apparatus 201. The CPU 252 of the POS apparatus 201 determines, on the basis of the determination result, whether the individual identification information received by the radio communication unit 210 is stored in the authentication table 25.

When the individual identification information is included in the authentication table 25 (Y in Act 405), the CPU 252 of the POS apparatus 201 causes the radio communication unit 210 to transmit and output both the individual identification information and authentication success notification (Act 406).

When the individual identification information is not included in the authentication table 25 (N in Act 405), the CPU 252 of the POS apparatus 201 causes the radio communication unit 210 to transmit and output both the individual identification information and authentication failure notification (Act 407). Subsequently, the CPU 252 executes error processing (Act 408). The error processing is processing for causing the display for store clerk 205 to display indication that the individual identification information is transmitted from the cellular phone 301, individual identification information of which is not stored in the authentication table 25.

Upon finishing the processing in Act 406 or Act 408, the CPU 252 finishes the individual identification information transmission processing.

FIG. 15B is a flowchart of a flow of individual identification information transmission processing performed in the cellular phone 301. In this modification, the CPU 352 of the cellular phone 301 stands by for the radio communication unit 304 to receive authentication notification instead of reception notification (Act 303a). The authentication notification is any one of authentication success notification and authentication failure notification transmitted and output from the POS apparatus 201.

When the radio communication unit 304 receives the authentication notification (Y in Act 303a), the CPU 352 determines whether individual identification information received together with the authentication information and the individual identification information stored in the EEPROM 353 coincide with each other (Act 304). When the CPU 352 determines in Act 304 that both the kinds of individual identification information do not coincide with each other (N in Act 304), the CPU 352 returns the processing to Act 303a. On the other hand, when the CPU 352 determines in Act 304 that both the kinds of individual identification information coincide with each other (Y in Act 304), the CPU 352 advances the processing to Act 304a.

In Act 304a, the CPU 352 determines content of the received authentication notification (Act 304a). When the received authentication notification is the authentication success notification (Y in Act 304a), the CPU 352 causes the terminal display unit 303 to display indication that the authentication is successful (Act 304b). Subsequently, the CPU 352 performs the processing in Act 101 and Act 102 (see FIG. 12B). On the other hand, when the authentication notification received in Act 304a is the authentication failure notification (N in Act 304a), the CPU 352 causes the terminal display unit 303 to display indication that the authentication fails (Act 304c). Upon finishing the processing, the CPU 352 finishes the transaction information display processing without standing by for the reception of transaction information and completion notification.

In the commodity sales data processing system 101 in this modification, the POS apparatus 201 determines whether the individual identification information transmitted and output from the cellular phone 301 coincides with the individual identification information stored in the authentication table 25. Only when both the kinds of individual identification information coincide with each other, the POS apparatus 201 transmits and outputs the transaction information by radio. Therefore, the supermarket 10 stores individual identification information of the cellular phone 301, on which the transaction information is desired to be displayed, in the authentication table 25 in advance. Consequently, the POS apparatus 201 transmits and outputs the transaction information only when the cellular phone 301 specified by the individual identification information is present near the POS apparatus 201.

The authentication table 25 stores an individual identification number of the cellular phone 301 of the customer 22 who performs member registration and downloads the transaction information display program 305 from the member registration site 24. Therefore, in the commodity sales data processing system 101 in this modification, only the terminal display unit 303 of the cellular phone 301 of the customer 22 who performs member registration displays the transaction information.

Obviously, numerous modifications and variations of the present invention are possible in light of the above teachings. It is therefore to be understood that within the scope of the appended claims, the invention may be practiced otherwise than as specifically described herein.

What is claimed is:

1. A commodity sales data processing system comprising:
a commodity sales data processing apparatus including a commodity-code input unit for inputting a commodity code, a first communication unit that executes near distance radio communication, and a first information processing unit that executes transmission output processing for causing the first communication unit to transmit and output transaction information based on the commodity code input from the commodity-code input unit; and
a customer-carried terminal including a terminal display unit that displays information, a second communication unit that executes the near distance radio communication, and a second information processing unit that executes information processing for executing display processing for causing the terminal display unit to display transaction information received by the second communication unit.

2. The system of claim 1, wherein
the second information processing unit causes the second communication unit to transmit and output a terminal code for specifying the customer-carried terminal,
the first information processing unit causes, when the first information processing unit determines that the first communication unit receives a terminal code, the first communication unit to transmit and output the terminal code together with the transaction information in the transmission output processing, and
the second information processing unit executes the display processing only when the second information processing unit determines that the terminal code received by the second communication unit together with the transaction information and the terminal code of the customer-carried terminal coincide with each other.

3. The system of claim 2, wherein
the commodity sales data processing apparatus includes a display unit for customer that displays information,
the first information processing unit executes, when the first information processing unit determines that the first communication unit does not receive a terminal code, processing for causing the display unit for customer to display the transaction information, and
the first information processing unit executes, when the first information processing unit determines that the first communication unit receives a terminal code, the transmission output processing without causing the display unit for customer to display the transaction information.

4. The system of claim 2, wherein the first information processing unit executes the transmission output processing when the first information processing unit accesses an authentication table stored in a storing unit, which defines a terminal code of the customer-carried terminal at the transmission output destination of the transaction information, and determines that the first communication unit receives the terminal code defined in the authentication table.

5. The system of claim 3, wherein the first information processing unit executes the transmission output processing when the first information processing unit accesses an authentication table stored in a storing unit, which defines a terminal code of the customer-carried terminal at the transmission output destination of the transaction information, and determines that the first communication unit receives the terminal code defined in the authentication table.

6. A commodity sales data processing apparatus comprising:
a commodity-code input unit for inputting a commodity code;
a first communication unit that executes near distance radio communication; and
a first information processing unit that executes transmission output processing for causing the first communication unit to transmit and output transaction information based on the commodity code input from the commodity-code input unit.

7. The apparatus of claim 6, wherein the first information processing unit causes, when the first information processing unit determines that the first communication unit receives a terminal code for specifying a customer-carried terminal, the first communication unit to transmit and output the terminal code together with the transaction information in the transmission output processing.

8. The apparatus of claim 7, further comprising a display unit for customer that displays information, wherein
the first information processing unit executes, when the first information processing unit determines that the first communication unit does not receive a terminal code, processing for causing the display unit for customer to display the transaction information, and
the first information processing unit executes, when the first information processing unit determines that the first communication unit receives a terminal code, the transmission output processing without causing the display unit for customer to display the transaction information.

9. The apparatus of claim 7, wherein the first information processing unit executes the transmission output processing when the first information processing unit accesses an authentication table stored in a storing unit, which defines a terminal code of the customer-carried terminal at the transmission output destination of the transaction information, and determines that the first communication unit receives the terminal code defined in the authentication table.

10. The apparatus of claim 8, wherein the first information processing unit executes the transmission output processing when the first information processing unit accesses an authentication table stored in a storing unit, which defines a terminal code of the customer-carried terminal at the transmission output destination of the transaction information, and determines that the first communication unit receives the terminal code defined in the authentication table.

11. A display method for transaction information comprising:
by a commodity sales data processing apparatus, which includes a commodity-code input unit for inputting a commodity code and a first communication unit that executes near distance radio communication, transmitting and outputting transaction information based on the commodity code input from the commodity-code input unit; and
by a customer-carried terminal, which includes a terminal display unit that displays information and a second communication unit that executes the near distance radio communication, receiving the transaction information and displaying the transaction information on the terminal display unit.

12. The method of claim 11, wherein
the customer-carried terminal stores a terminal code for specifying the customer-carried terminal,
the method further includes transmitting and outputting the terminal code by the customer-carried terminal before the commodity sales data processing apparatus transmits and outputs the transaction information,
in the transmitting and outputting the transaction information, the commodity sales data processing apparatus transmits and outputs the terminal code together with the transaction information when the commodity sales data processing apparatus receives the terminal code, and
the receiving the transaction information and displaying the transaction information on the terminal display unit is performed only when the terminal code received by the customer-carried terminal together with the transaction information and the terminal code stored by the customer-carried terminal coincide with each other.

13. The method of claim 12, wherein
the commodity sales data processing apparatus includes a display unit for customer that displays information,
in the transmitting and outputting the transaction information, the commodity sales data processing apparatus causes the display unit for customer to display the transaction information when the commodity sales data processing apparatus does not receive a terminal code, and
in the transmitting and outputting the transaction information, the commodity sales data processing apparatus transmits and outputs the transaction information without causing the display unit for customer to display the transaction information when the commodity sales data processing apparatus receives a terminal code.

14. The method of claim 12, further comprising, by the commodity sales data processing apparatus, accessing an authentication table stored in a storing unit, which defines a terminal code of the customer-carried terminal at the transmission output destination of the transaction information, wherein
the commodity sales data processing apparatus transmits and outputs the transaction information only when the commodity sales data processing apparatus receives the terminal code defined in the authentication table.

15. The method of claim 13, further comprising, by the commodity sales data processing apparatus, accessing an authentication table stored in a storing unit, which defines a terminal code of the customer-carried terminal at the transmission output destination of the transaction information, wherein
the commodity sales data processing apparatus transmits and outputs the transaction information only when the commodity sales data processing apparatus receives the terminal code defined in the authentication table.
